(19) United States
(12) Patent Application Publication
(10) Pub. No.: US 2003/0074597 A1
(43) Pub. Date: Apr. 17, 2003

(54) Repair supporting method, repair supporting server and repair subject multi-functional peripheral

(75) Inventors: Hirofumi Harada, Chiba-ken (JP); Ichiro Hase, Tokyo (JP); Toshiyuki Oda, Tokyo (JP); Yaeko Harada, Tokyo (JP); Kei Kato, Tokyo (JP); Leonhard Gelbrich, Kanagawa-ken (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/252,117

(22) Filed: Sep. 23, 2002

(30) Foreign Application Priority Data
Oct. 10, 2001 (JP) 2001-312950

(51) Int. Cl. H02H 3/05

(52) U.S. Cl. 714/5

(57) ABSTRACT

A service center judges parts required for repair according to the trouble information received from a multi-functional peripheral (MFP), searches servicemen carrying repair parts based on the contents of the serviceman carrying parts memory, and contacts a portable terminal carried by an applicable servicemen. Then, by grasping the condition of the serviceman, e.g., whether he is in working, traveling or taking a rest, stores the condition of servicemen in the serviceman condition memory. In succession, based on the contents of the serviceman positioning memory, the serviceman condition memory and the MFP installation place memory, the service center searches a serviceman who is able to go most fast to the installing place of a MFP to be repaired among servicemen who carry required repair parts, and gives a repair direction to a portable terminal carried by this searched serviceman together the installing place of the MFP and contents of the trouble.

### BACKGROUND OF THE INVENTION

This invention relates to a repair supporting method, a repair supporting server and a repair subject multi-functional peripheral.

The Published Japanese Patent Application No. 11-136377 discloses a maintenance system for directing the repair when a trouble requiring repair is generated on a multi-functional peripheral that is subject to repair and informed to a service center. This maintenance system searches a serviceman who is at the position most close to a multi-functional peripheral that is subject to repair by a serviceman searching unit when a trouble is generated on it and sends a maintenance order to a portable terminal carried by this serviceman. Further, this system manages the status of repair parts carried by servicemen, diagnoses contents of a trouble generated on a peripheral subject to maintenance, and searches a serviceman who is positioning most close to the peripheral among servicemen who are carrying parts required for maintenance considering the installing place of that peripheral, contents of the trouble, the current positioning of servicemen and parts carried by servicemen, and sends a maintenance order to a portable terminal carried by the searched serviceman.

By the way, servicemen are not always in the standby state but are making the routine run of multi-functional peripheral that are subject to maintenance according to the original periodic maintenance schedule. Therefore, even when a serviceman who carries parts required for solving a trouble is at the position close to a multi-functional peripheral that is subject to maintenance, generating a trouble, this serviceman may possibly be in the midst of the maintenance/inspection work.

In such a case, when a maintenance order is given only on the condition that a serviceman carries parts required for the maintenance and is positioning most close to a multi-functional peripheral that is subject to maintenance, this serviceman goes to the place of a multi-functional peripheral subject to maintenance, generating a trouble after completing the current maintenance/inspection work. Thus, a rapid action cannot be taken, as much time is needed to go to the place of the multi-functional peripheral subject to maintenance, generating a trouble from the receipt of the notice of maintenance order.

### SUMMARY OF THE INVENTION

It is an object of the present invention to provide a repair support method, a repair support server and multi-functional peripheral subject to repair, making it always possible to dispatch a serviceman carrying repair parts to an multi-functional peripheral generating a trouble requiring the repair rapidly in a short time.

According to the present invention, a repair support for storing data showing repair parts carried by plural servicemen in a memory, storing data showing an installation place of a multi-functional peripheral subject to repair in a memory, managing data showing current positions of the servicemen by a service center, and managing data showing the current condition of servicemen by the service center according to the communication with servicemen, is provided. The method comprises: judging parts required for repair by the service center based on trouble information requested for repair from the multi-functional peripheral subject to repair; searching a serviceman carrying parts required for repair based on repair parts data stored in the memory by the service center; searching a serviceman who is able to go most fast to an installation place of a multi-functional peripheral subject to repair among the servicemen who are carrying parts required for repair by the service center based on the current positioning data and the current condition data of servicemen who are being managed and the installation place data of an multi-functional peripheral subject to repair stored in the memory; and notifying the repair direction to a portable terminal carried by a service man who is searched to be capable of most fast going to the installation place of the multi-functional peripheral to be repaired.

Further, according to the present invention, a service connected to plural multi-functional peripheral to be repaired through a network and portable terminals carried by plural servicemen connected through a wireless communication, is provided. The service center comprises: a memory to store data showing repair parts carried by the plural servicemen and data showing an installation places of the plural multi-functional peripheral to be repaired; managing means for managing data showing the current positions of the servicemen and data showing the current conditions of the servicemen through the communication with them; judging means for judging parts required for repair based on trouble information for which the repair is requested from the multi-functional peripheral to be repaired; first searching means for searching servicemen carrying parts required for the repair based on the repair parts data stored in the memory; second searching means for searching a serviceman who is able to go most fast to the installation place of the multi-functional peripheral to be repaired among the servicemen searched by the first searching means based on the current positioning data and the current condition data of the servicemen managed by the managing means; and notifying means for notifying the repair direction to the portable terminal carried by the serviceman searched by the second searching means.

Further, according to the present invention, a multi-functional peripheral connected to a service center that is connected to portable terminals carried by plural servicemen through a network is provided. The multi-functional peripheral comprises: means for gasping contents of trouble and preparing trouble information; means for sending the trouble information prepared by the preparing means to the service center through the network; and means for displaying prescribed information for informing a user.

### BRIEF DESCRIPTION OF THE DRAWINGS

FIG. 1 is a block diagram showing the structure of the entire method involved in an embodiment of the present invention;

FIG. 2 is a block diagram showing the structure of a multi-functional peripheral (MFP) as a multi-functional peripheral that is subject to repair in the embodiment of the present invention;

FIG. 3 is a block diagram showing the structure of a service center having a repair support server involved in the embodiment of the present invention;

FIG. 4 is a diagram showing a structure of an essential memory of an HDD of the service center in the embodiment of the present invention;

FIG. 5 is a flowchart showing a trouble processing in the multi-functional peripheral (MFP) in the embodiment of the present invention;

FIG. 6 is a flowchart showing a trouble information receiving process at the service center in the embodiment of the present invention; and

FIG. 7 is a flowchart showing the trouble information receiving process at the service center in the embodiment of the present invention.

### DETAILED DESCRIPTION OF THE INVENTION

A preferred embodiment of the present invention will be described below referring to the attached drawings.

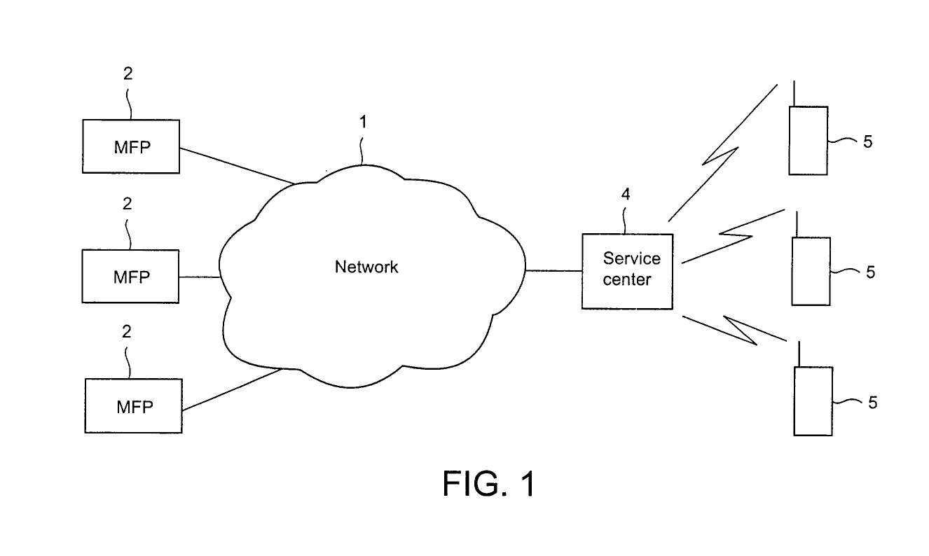

As shown in FIG. 1, a number of multi-functional peripherals (MFP) 2 that are subject to repair are connected to a service center 4, comprising a host computer and others through a network 1. The service center 4 is capable of communicating with each of portable terminals, for example, PHS (Personal Handy phone System) 5 carried by plural servicemen.

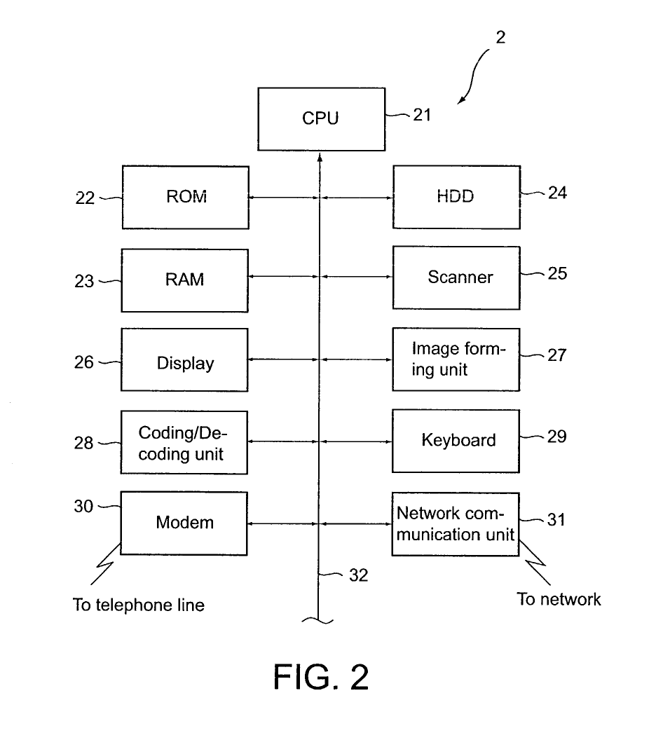

Each of the multi-functional peripherals (MFP) 2 is composed of a CPU (Central Processing Unit) 21 comprising a main body of a control unit, a ROM (Read Only Memory) 22, storing program data for the CPU 21 to control component units and variously process data, a RAM (Random Access Memory) 23, providing a temporary memory required for the CPU 21 in processing various data, and an HDD (Hard Disk Drive) for storing various data as shown in FIG. 2.

Further, each of multi-functional peripherals 2 comprises: a scanner 25 for reading images from an original document optically and outputting image data, a liquid crystal display 26 for displaying character and image data, etc., an image forming unit 27 equipped with a photosensitive drum, a charger, an exposure unit, a developing unit and a fixing device for transferring a toner image on a recording paper from supplied image data according to the electro-photographic method, and forming an image on a recording paper by heating and fixing this toner image, and a coding/decoding unit 28 for executing the coding/decoding of image data in the facsimile communication.

Further, the multi-functional peripheral (MFP) 2 comprises: a keyboard 29 with keys provided for selecting and executing various functions of the multi-functional peripheral, a modem 30 connected to a telephone line for receiving/sending image data through the telephone line in the facsimile communication, and a network communication unit 31 for communicating with the service center 4 through the network.

The CPU 21, ROM 22, RAM 23, HDD 24, scanner 25, display 26, image forming unit 27, coding/decoding unit 28, keyboard 29, modem 30 and network communication unit 31 are electrically connected each other by a bus line 32.

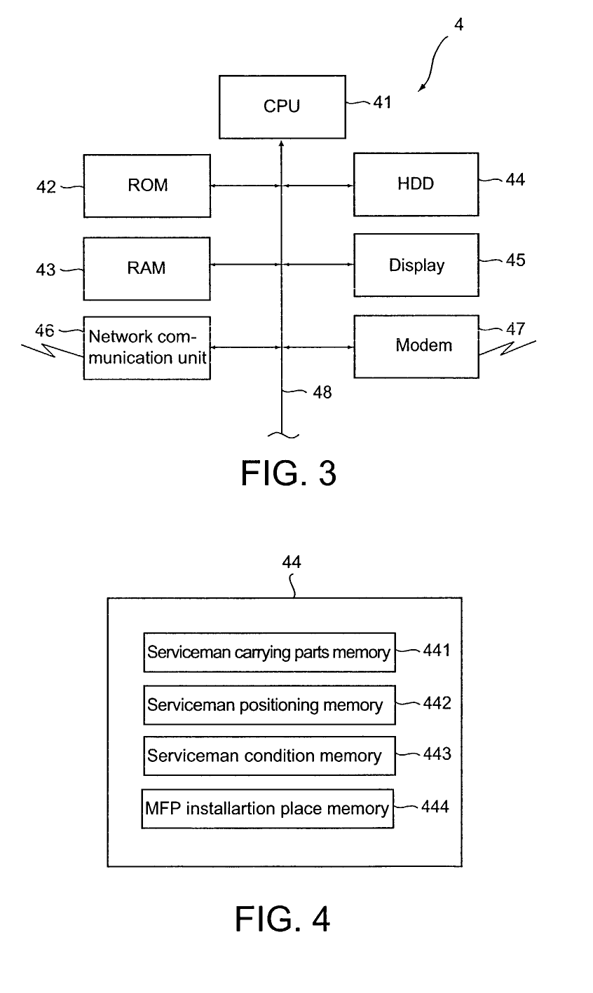

The service center 4 is composed of a CPU 41 comprising a main body of a control unit, a ROM 42 storing program data for this CPU 41 to control component units and variously processing data, a RAM 43 provided with a temporary memory for the CPU 41 to process various data, and an HDD 44 for storing various data as shown in FIG. 3.

The service center 4 is further composed of liquid crystal or CRT display 45 for displaying and outputting various processed data, a network communication unit 46 which is connected to the network 1 for the network communication with multi-functional peripherals 2, and a modem 47 which is connected to the telephone line for communication with a PHS 5 carried by servicemen.

The CPU 41, ROM 42, RAM 43, HDD 44, display 44, a bus line 48 electrically connects network communication unit 46 and modem 47 mutually.

The HDD 44 is composed of a serviceman carrying parts memory 441 wherein repair parts carried by a serviceman are registered in advance, a serviceman positioning memory 442 wherein the information on current position of a PHS 5 carried by each serviceman is taken in and stored by the modem 47, a serviceman condition memory 443 wherein the information on the current condition of a serviceman is taken in and stored from the PHS 5 of each serviceman by the modem 47, and a MFP installation place memory 444 wherein the installation place of each MFP such as an address, a name of shop, etc. are registered in advance as shown in FIG. 4. The current serviceman conditions are classified in “Working”, “Traveling” and “Taking Rest” and these conditions are stored in the serviceman condition memory 443 when a serviceman notifies the own current condition to the service center using own PHS 5. Further, a means for storing the current position information of the PHS 5 carried by each serviceman in the serviceman positioning memory as the current positional information of each serviceman comprises a position management means.

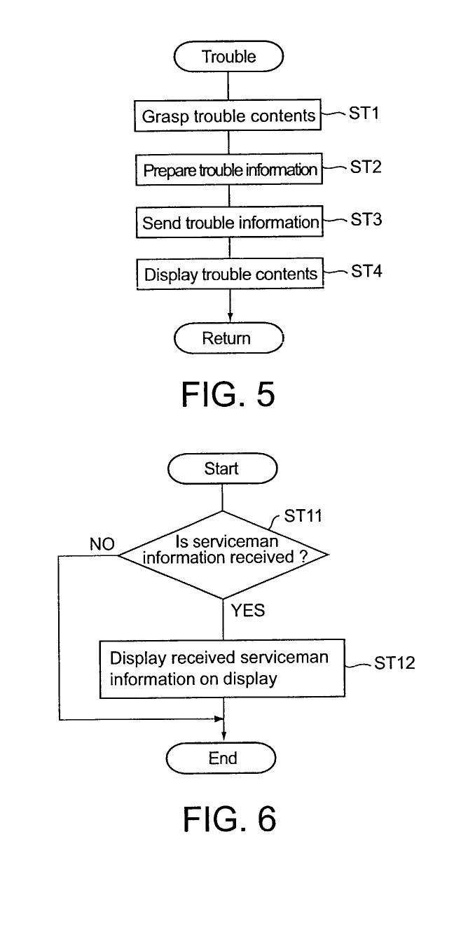

Each multi-functional peripheral (MFP) 2 performs the trouble processing as shown in FIG. 5 when a trouble requiring to ask the repair is generated. That is, the MFP 2 grasps the contents of the generated trouble in Step ST 1, prepares a trouble information for notifying the contents of the trouble in Step ST 2, transmits the information on a trouble requiring the repair to the service center 4 through the network 1 from the network communication unit 31 in Step ST 3 (the sending means). Then, the trouble contents are displayed on the display 26 to inform a user in Step ST 4.

Further, when the network communication unit 31 receives (the receiving means) the serviceman information from the service center 4 in Step ST 11, each multi-functional peripheral 2 displays the received serviceman information on the display 26 to inform a user in Step ST 12 as shown in FIG. 6 (the display means).

The serviceman information at this time is the information to inform a user of a name of serviceman who is able to go and how soon (time) to a user.

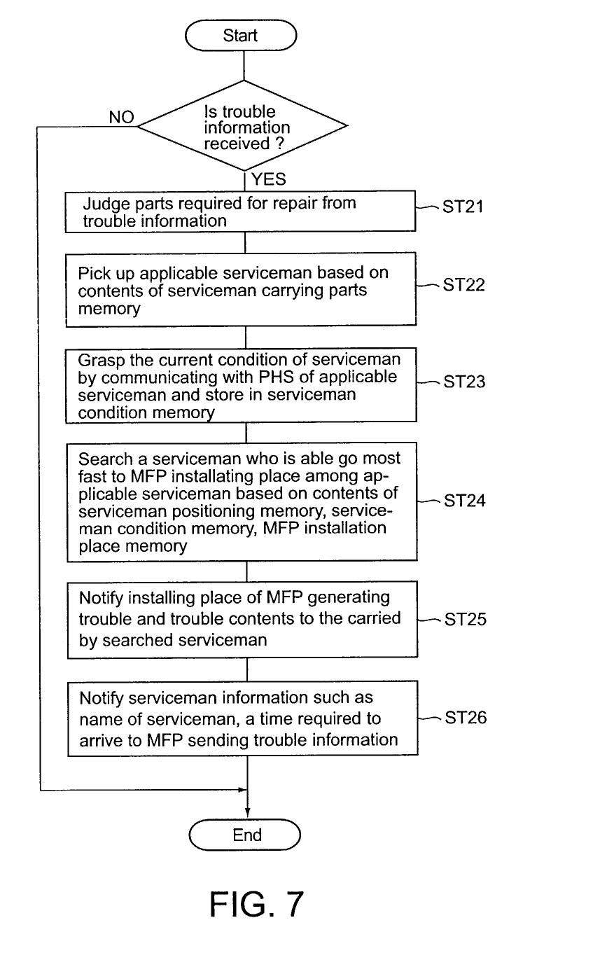

The service center 4, when received the trouble information from the MPF 2 by the network communication unit 4, performs the trouble information receiving process shown in FIG. 7. That is, parts required for the repair are judged from the received trouble information in Step ST 21 and an applicable serviceman who has required parts for the repair is picked up based on the contents of the serviceman carrying parts memory 441 (the pick-up means) in Step ST 22.

In succession, the PHS carried by the applicable picked up serviceman is communicated from the modem 47 in Step ST 23. When the current condition of the serviceman as to whether in working, traveling or taking a rest is informed, the condition of the serviceman is grasped and stored in the serviceman condition memory 443 (the condition managing means).

Then, a serviceman capable of moving fastest to the installing place of the MFP 2 to be repaired is searched among applicable servicemen carrying parts required for the repair based on the contents of the serviceman positioning memory 442, the serviceman condition memory 443 and the MFP installation place memory 444 (the searching means) in Step ST 24.

Here, depending on the condition of a serviceman, for instance, currently in working or traveling or taking a rest, if a serviceman is currently in working even when he is positioning at a distance most close to a MFP 2 to be repaired, he is not able to go to that MFP 2 until the work is completed. Accordingly, in this case this serviceman may be judged not to be able to go to the installation place of the MFP 2 to be repaired. Further, even when positioning far away from a MFP 2 to be repaired, a serviceman is able to immediately go to the place of that MFP 2 installed when he is taking a rest or traveling. Therefore, the serviceman may be judged to be able to go to the installation place of that MFP 2 most fast.

Thus, when a serviceman who is judged to be able to go to the place of a MFP 2 installed most fast is searched, a repair direction is sent to the PHS carried by the searched serviceman from the modem 47 and an installation place of a MFP 2 generating a trouble and requiring the repair and contents of the trouble are notified (the repair direction notifying means) in Step ST 25.

Further, such information as a name of serviceman, a time required to arrive the installation place of the MFP 2, etc. are notified to the MFP 2 sending the trouble information and requiring the repair from the network communication unit 46 in Step ST 26 (the serviceman information notifying means).

Thus, a series of processes is now completed.

In this structure, when a trouble requiring the repair is generated in a MFP 2, trouble information is notified to the service center 4. In the service center 4, when the trouble information is received, parts required for solving the trouble are judged and a serviceman carrying those parts is picked up according to the contents of the serviceman carrying parts memory 441.

Then, the PHS of the picked up serviceman is contacted and asked the current condition. When the current condition is received, it is stored in the serviceman condition memory 443.

Then, the current position of the picked up serviceman is judged according to the contents of the servicemen positioning memory 442. Further, the current condition of the serviceman is judged according to the contents of the serviceman condition memory 443. In addition, the location where the MFP 2 requiring the repair is installed is judged according to the contents of the MFP installation place memory 444. Based on these judgments, which serviceman is able to arrive at the installation place of the MFP 2 is judged.

For example, a serviceman who is at a position most close to the installation place of a MFP 2 is not able to arrive at a MFP 2 requiring the repair most fast if he is in working and therefore, this serviceman is excluded from the search. On the other hand, a serviceman who is in traveling to a next periodic checking place that is somewhat far from the MFP 2 to be repaired is able to go to the place of the MFP 2 immediately. So, this serviceman is searched as an applicable serviceman who is able to go to a MFT 2 generating a trouble most fast.

To a PHS 5 carried by this searched serviceman, a repair direction is notified together with an installation place of a MFP 2 generating a trouble and contents of the trouble. Thus, the serviceman who received the notification immediately starts to go to the installation place of the MFP 2 generating the trouble.

On the other hand, serviceman information is sent from the service center 4 to the MFP 2 generating the trouble to inform a name of serviceman who goes to the place and a time needed to arrive the place. The MFP 2 receives this serviceman information and a name of this serviceman and an approximate time to arrive at the place are displayed on the display 26. As a result, a user is able to know that the trouble contents are informed to the service center 4 and a serviceman is coming and a time to arrive the place of the MFP 2.

Thus, among servicemen carrying repair parts, a serviceman who is able to go most fast to a MFP 2 generating a trouble is searched taking his current position and condition into consideration, and a repair direction is given to this serviceman. Accordingly, it is possible to send a serviceman always to a MFP 2 generating a trouble rapidly in a short time and improve the service to a user. Further, a user is able to know that a serviceman is coming and how fast arrives by observing the information on the display 26 of a MFP 2 and therefore, the service to users can be further improved.

In this embodiment, the invention is explained using a PHS as a portable terminal but a cell phone, a laptop computer (a notebook-sized PC) is also usable.

Further, this embodiment describes the invention using a multi-functional peripheral equipped with such multiple functions as copying machine, facsimile, printer as an multi-functional peripheral subject to repair but is not restricted to this peripheral and an ordinary copying only machine, a facsimile only machine may be usable.

In addition, in this embodiment a program stored in a ROM for executing various functions by the service center and MFP 2 is described but a program can be stored in a recording medium for executing various functions by reading therefrom by a PC. A recording medium in this case can be in any kind that is able to record programs and read by PC; for example, floppy disk, hard disk, magnetic disk, optical disk (CD-ROM, CD-R, DVD, etc.), magnet-optical disk (MO, etc.), semiconductor memory, etc. The functions in this embodiment are not restricted to media independent from a computer but can be programs transmitted through LAN, Internet, etc. and downloaded and stored or temporarily stored.

As described above, according to the present invention, it is possible to provide a repair support method capable of always dispatching a serviceman carrying repair parts rapidly in a short time to a multi-functional peripheral generating a trouble requiring the repair.

Further, according to the present invention, it is possible to provide a repair support method capable of having a user to know a serviceman coming to repair of a multi-functional peripheral generating a trouble and improving the service to users.

What is claimed is:

1. A repair support method for storing data showing repair parts carried by plural servicemen in a memory, storing data showing an installation place of a multi-functional peripheral subject to repair in a memory, managing data showing current positions of the servicemen by a service center, and managing data showing the current condition of servicemen by the service center according to the communication with servicemen, the method comprising;
judging parts required for repair by the service center based on trouble information requested for repair from the multi-functional peripheral subject to repair;
searching a serviceman carrying parts required for repair based on repair parts data stored in the memory by the service center;
searching a serviceman who is able to go most fast to an installation place of a multi-functional peripheral subject to repair among the servicemen who are carrying parts required for repair by the service center based on the current positioning data and the current condition data of servicemen who are being managed and the installation place data of an multi-functional peripheral subject to repair stored in the memory; and
notifying the repair direction to a portable terminal carried by a service man who is searched to be capable of most fast going to the installation place of the multi-functional peripheral to be repaired.

2. The method according to claim 1, further comprising:
notifying, by the service center, the searched serviceman going to the multi-functional peripheral from which the trouble information is sent out.

3. The method according to claim 2, wherein the notifying step includes notifying a time required for the serviceman to arrive at the multi-functional peripheral to be repaired.

4. The method according to claim 1, wherein the memory that is storing data showing repair parts carried by the servicemen and the memory that is storing data showing the installation place of the multi-functional peripheral subject to repair are provided in the service center.

5. The method according to claim 1, wherein the multi-functional peripheral subject to repair and the service center are connected each other through a network.

6. The method according to claim 5, wherein the service center and the portable terminals carried by the servicemen are connected through a wireless communication.

7. A service center connected to plural multi-functional peripheral to be repaired through a network and portable terminals carried by plural servicemen connected through a wireless communication, comprising:
a memory to store data showing repair parts carried by the plural servicemen and data showing an installation places of the plural multi-functional peripheral to be repaired;
managing means for managing data showing the current positions of the servicemen and data showing the current conditions of the servicemen through the communication with them;
judging means for judging parts required for repair based on trouble information for which the repair is requested from the multi-functional peripheral to be repaired;
first searching means for searching servicemen carrying parts required for the repair based on the repair parts data stored in the memory;
second searching means for searching a serviceman who is able to go most fast to the installation place of the multi-functional peripheral to be repaired among the servicemen searched by the first searching means based on the current positioning data and the current condition data of the servicemen managed by the managing means; and
notifying means for notifying the repair direction to the portable terminal carried by the serviceman searched by the second searching means.

8. The service center according to claim 7, wherein the notifying means includes second notifying means for notifying that the searched serviceman is going to the multi-functional peripheral that sent the trouble information.

9. The service center according to claim 8, wherein the notification means includes third notifying means for notifying the multi-functional peripheral requiring the repair of a time of a servicemen required for going toward the multi-functional peripheral.

10. A multi-functional peripheral connected to a service center to which plural portable terminals carried by plural servicemen through a wireless communication through a network, comprising:
grasp means for grasping contents of trouble to prepare trouble information;
sending means for sending the trouble information prepared by the trouble information preparing means to the service center; and
display means for displaying prescribed information for informing a user.

11. The multi-functional peripheral according to claim 10, further comprising:
receiving means for receiving serviceman information from the service center;
wherein the displaying means displays the serviceman information received by the receiving means.

12. The multi-functional peripheral according to claim 11, wherein the serviceman information is a time required for a serviceman to come for solving the trouble generated on the multi-functional peripheral.

13. The multi-functional peripheral according to claim 10, wherein the display means displays the trouble contents.
